(19) United States
(12) Patent Application Publication
(10) Pub. No.: US 2024/0153055 A1
(43) Pub. Date: May 9, 2024

(54) TECHNIQUES FOR PREPROCESSING IMAGES TO IMPROVE GAIN MAP COMPRESSION OUTCOMES

(71) Applicant: Apple Inc., Cupertino, CA (US)

(72) Inventors: Nicolas P. BONNIER, Mountain View, CA (US); Jackson K. ROLAND, San Jose, CA (US)

(21) Appl. No.: 18/501,976

(22) Filed: Nov. 3, 2023

Related U.S. Application Data
(60) Provisional application No. 63/383,033, filed on Nov. 9, 2022.

(51) Int. Cl. G06T 5/00; G06T 9/00; G06V 10/60

(52) U.S. Cl. CPC G06T 5/009; G06T 9/00; G06V 10/60; G06T 2207/20208

(57) ABSTRACT

This application describes techniques for preprocessing images to improve gain map compression outcomes. A gain map can be generated by comparing a first image to a second image and subsequently compressed to form a compressed gain map. The compressed gain map can combined with a compressed version of the first image to form a compressed enhanced image. The compressed enhanced image can be later uncompressed to generate an uncompressed version of the first image and the gain map applied to the uncompressed version of the first image to generate a version of the second image to provide for reproduction on a target display. The compressed version of the first image and the compressed gain map can be generated separately by an image compression module and a gain map compression module or jointly by a combined gain map generation and compression module.

### CROSS-REFERENCE TO RELATED APPLICATIONS

The present application claims the benefit of U.S. Provisional Application No. 63/383,033, entitled “TECHNIQUES FOR PREPROCESSING IMAGES TO IMPROVE GAIN MAP COMPRESSION OUTCOMES,” filed Nov. 9, 2022, the content of which is incorporated by reference herein in its entirety for all purposes.

### FIELD OF INVENTION

The embodiments described herein set forth techniques for preprocessing images to improve gain map compression outcomes. A gain map can be generated by comparing a first image to a second image and subsequently compressed to form a compressed gain map. The compressed gain map can combined with a compressed version of the first image to form a compressed enhanced image. The compressed enhanced image can be later uncompressed and the gain map applied to the first image to generate a version of the second image to provide for reproduction on a target display.

### BACKGROUND

The dynamic range of an image refers to the range of pixel values between the image's lightest and darkest parts (also referred to as “luminance”). Notably, image sensors capture a limited range of luminance in a single exposure of a scene, relative to human visual perception of the scene. An image with a limited range is referred to herein as a standard dynamic range (SDR) image.

Despite image sensor limitations, improvements in computational photography allow for a greater range of luminance values to be captured by an image sensor using multiple images processed together to form an image with a broader range, referred to herein as a high dynamic range (HDR) image. The HDR image can be formed by (1) capturing multiple bracketed images, i.e., individual SDR images each captured using different exposure values (also called “stops”), and (2) merging the bracketed SDR images into a single HDR image that incorporates aspects from the different exposures. The single HDR image includes a wider dynamic range of luminance values compared to a narrower range luminance values in each of the individual SDR images. The HDR image can be considered superior to an SDR image, as a greater amount of information for the scene is retained by the HDR image than the individual SDR images.

Display devices capable of displaying HDR images with a wider range of luminance values are becoming more accessible due to advancements in design and manufacturing technologies. A majority of display devices currently in use (and continuing to be manufactured), however, are only capable of displaying SDR images with a more limited range of luminance values. Consequently, HDR images must be converted (i.e., downgraded) to an SDR image equivalent for display on a device with only an SDR-capable display. Conversely, devices with HDR-capable displays may attempt to convert (i.e., upgrade) an SDR image to an HDR image equivalent to display via an HDR-capable display.

Existing conversion techniques can produce inconsistent and/or undesirable results. In particular, downgrading an HDR image to an SDR image—which can be performed through a tone mapping operation—can introduce visual artifacts (e.g., banding) into the resulting SDR image that often are uncorrectable with additional image processing. Conversely, upgrading an SDR image to an HDR image—which can be performed through an inverse tone mapping operation— involves applying varying levels of guesswork, which also can introduce uncorrectable visual artifacts.

Moreover, retaining all of the originally captured SDR images with the HDR image can use up limited storage space and can require additional communication bandwidth to transfer all of images between devices.

Accordingly, what is needed are technique for enabling images to be efficiently and accurately transformed between different states. For example, it is desirable to enable an SDR image to be upgraded to an HDR counterpart (and vice versa) without relying on the foregoing (and deficient) conversion techniques.

### SUMMARY OF INVENTION

The embodiments described herein set forth techniques for preprocessing images to improve gain map compression outcomes. A gain map can be generated by comparing a first image to a second image and subsequently compressed to form a compressed gain map. The compressed gain map can combined with a compressed version of the first image to form a compressed enhanced image. The compressed enhanced image can be later uncompressed and the gain map applied to the first image to generate a version of the second image to provide for reproduction on a target display. In some embodiments, the first image includes a standard dynamic range (SDR) image, and the second image includes a high dynamic range (HDR) image. In some embodiments, the first image includes an SDR image selected from multiple SDR images and the second image includes an HDR image derived from a combination of the multiple SDR images. In some embodiments, the gain map is determined by comparing luminance values for pixels in the HDR image to luminance values for corresponding pixels in the SDR image. In some embodiments, a full-resolution version of the gain map includes a gain value for each pixel in the SDR and HDR images, while a reduced-resolution version of the gain map includes gain values for groups of two or more pixels in the SDR and HDR images. In some embodiments, the gain map is determined at ½ or ¼ resolution compared to the SDR and HDR images. In some embodiments, the compressed gain map is generated by processing the gain map (at full resolution or at a reduced resolution) using a first (gain map) compression scheme, and the compressed version of the first image is generated by processing the first image using a second (image) compression scheme. In some embodiments, the gain map is generated by comparing luminance values in the SDR image to luminance values in the HDR image. In some embodiments, the gain map is generated by comparing luminance values in a compressed version of the SDR image (or a compressed version of the HDR image) to luminance values in the (uncompressed) HDR image (or the uncompressed SDR image). In some embodiments, the compressed enhanced image includes a compressed version of an image derived from the SDR image and the HDR image jointly determined with a compressed version of the gain map (or jointly determined with an uncompressed version of the gain map, which is subsequently compressed), the compressed version of the gain map included together with the compressed version of the image to form the compressed enhanced image. In some embodiments, the compressed enhanced image is stored in a non-volatile storage medium, locally accessible by the computing device and/or remotely accessible by the computing device and possibly by other computing devices, e.g., via a cloud-network based service. In some embodiments, a second computing device obtains the compressed enhanced image, extracts the compressed version of the image from the compressed enhanced image, generates an uncompressed version of the image from the compressed version of the image, generates an uncompressed version of the gain map from the compressed version of the gain map, and applies the uncompressed version of the gain map to the uncompressed version of the image to generate a second image formatted for display by the second computing device. The second image has a dynamic range of luminance values that differs from a dynamic range of luminance values for the uncompressed version of the image. In some embodiments, the second image is an HDR image, and the uncompressed version of the image is an SDR image. In some embodiments, the compressed version of the first image and the compressed version of the gain map are generated separately by an image compression module and a gain map compression module or jointly by a combined gain map generation and compression module. In some embodiments, the computing device generates a gain map, compresses the gain map to form the compressed version of the gain map, decompresses the compressed version of the gain map to generate an uncompressed version of the gain map, compares the (original) gain map to the uncompressed version of the gain map to determine an error map, and stores the error map with the compressed version of the gain map to be used when creating the second image formatted for display by the second computing device.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an overview of a computing device that can be configured to perform the various techniques described herein, according to some embodiments.

FIGS. 2A-2E illustrate a sequence of conceptual diagrams of a technique for generating a gain map based on an SDR image and an HDR image, according to some embodiments.

FIGS. 3A-3E illustrate a sequence of conceptual diagrams for generating a compressed enhanced image based on a first image and a second image, according to some embodiments.

FIG. 4 illustrates a diagram of an example of generating an HDR image for display by a computing device from a compressed enhanced image, according to some embodiments.

FIGS. 5A and 5B illustrates flowcharts of exemplary methods for image management by computing devices, according to some embodiments.

FIG. 6 illustrates a detailed view of a computing device that can be used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all of these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting such that other embodiments can be used, and changes can be made without departing from the spirit and scope of the described embodiments.

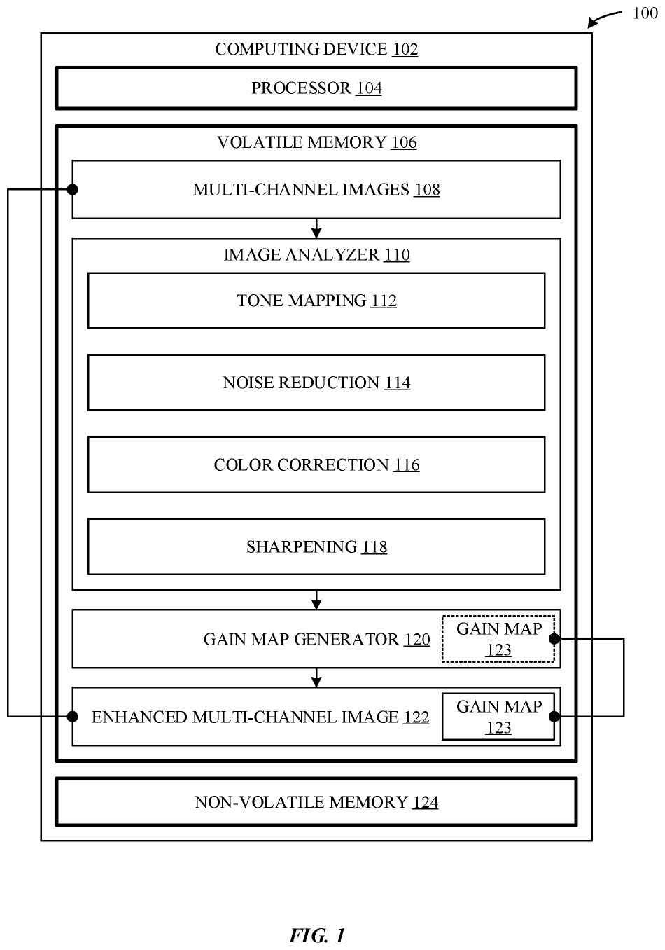

Representative embodiments set forth herein disclose techniques for generating gain maps based on acquired images. In particular, a gain map can be generated by comparing a first image to a second image. The gain map can then be embedded into the first image to enable the second image to be efficiently reproduced using the first image and the gain map. A more detailed description of these techniques is provided below in conjunction with FIGS. 1, 2A-2E, 3A-3E, 4, 5A, 5B, and 6.

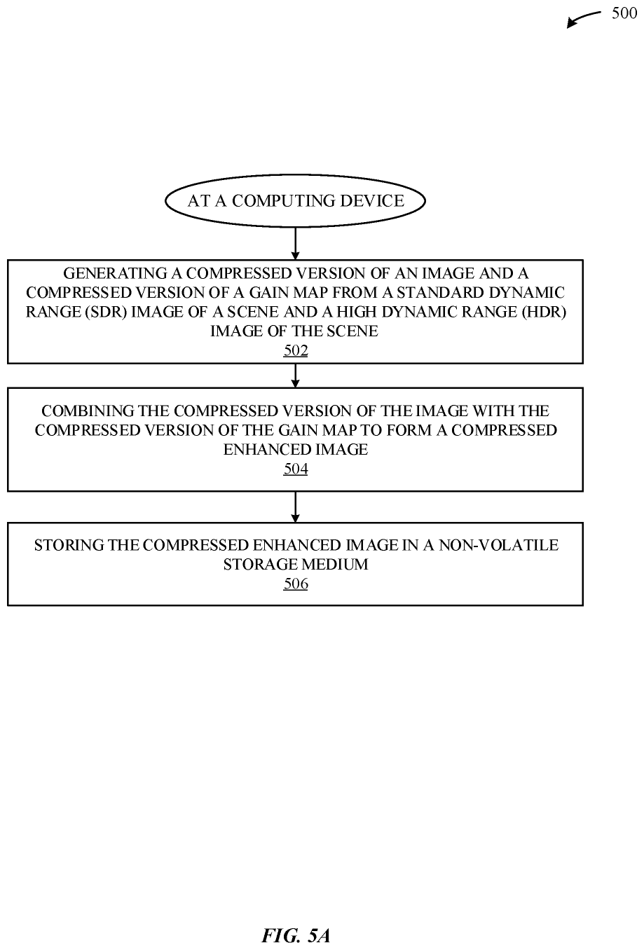

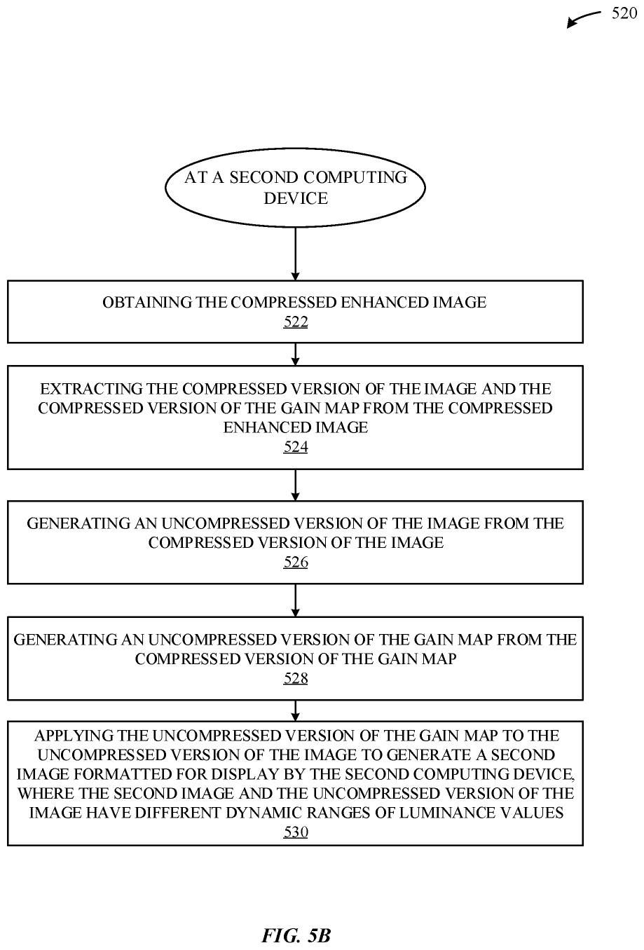

FIG. 1 illustrates an overview 100 of a computing device 102 that can be configured to perform the various techniques described herein. As shown in FIG. 1, the computing device 102 can include a processor 104, a volatile memory 106, and a non-volatile memory 124. It is noted that a more detailed breakdown of example hardware components that can be included in the computing device 102 is illustrated in FIG. 5, and that these components are omitted from the illustration of FIG. 1 merely for simplification purposes. For example, the computing device 102 can include additional non-volatile memories (e.g., solid-state drives, hard drives, etc.), other processors (e.g., a multi-core central processing unit (CPU)), a graphics processing unit (GPU), and so on). According to some embodiments, an operating system (OS) (not illustrated in FIG. 1) can be loaded into the volatile memory 106, where the OS can execute a variety of applications that collectively enable the various techniques described herein to be implemented. For example, these applications can include an image analyzer 110 (and its internal components), a gain map generator 120 (and its internal components), one or more compressors (not illustrated in FIG. 1), and so on.

As shown in FIG. 1, the volatile memory 106 can be configured to receive multi-channel images 108. The multi-channel images 108 can be provided, for example, by a digital imaging unit (not illustrated in FIG. 1) that is configured to capture and process digital images. According to some embodiments, a multi-channel image 108 can be composed of a collection of pixels, where each pixel in the collection of pixels includes a group of sub-pixels (e.g., a red sub-pixel, a green sub-pixel, a blue sub-pixel, etc.). It is noted that the term “sub-pixel” used herein can be synonymous with the term “channel.” It is also noted that the multi-channel images 108 can have different resolutions, layouts, bit-depths, and so on, without departing from the scope of this disclosure.

According to some embodiments, a given multi-channel image 108 can represent a standard dynamic range (SDR) image that constitutes a single exposure of a scene that is gathered and processed by the digital imaging unit. A given multi-channel image 108 can also represent a high dynamic range (HDR) image that constitutes multiple exposures of a scene that are gathered and processed by the digital imaging unit. To generate an HDR image, the digital imaging unit may capture a scene under different exposure brackets, e.g., three exposure brackets that are often referred to as “EV0”, “EV-”, and “EV+”. Generally, the EVO image corresponds to a normal/ideal exposure for the scene (typically captured using auto-exposure settings of the digital imaging unit); the EV− image corresponds to an under-exposed image of the scene (e.g., four times darker than EV0), and the EV+ image corresponds to an over-exposed image of the scene (e.g., four times brighter than EV0). The digital imaging unit can combine the different exposures to produce a resultant image that incorporates a greater range of luminance relative to SDR images. It is noted that the multi-channel images 108 discussed herein are not limited to SDR/HDR images. On the contrary, the multi-channel images 108 can represent any form of digital image (e.g., scanned images, computer-generated images, etc.) without departing from the scope of this disclosure.

As shown in FIG. 1, the multi-channel images 108 can (optionally) be provided to the image analyzer 110. According to some embodiments, the image analyzer 110 can include various components that are configured to process/modify the multi-channel images 108 as desired. For example, the image analyzer 110 can include a tone mapping unit 112 (e.g., configured to perform global/local tone mapping operations, inverse tone mapping operations, etc.), a noise reduction unit 114 (e.g., configured to reduce global/local noise in the multi-channel image), a color correction unit 116 (e.g., configured to perform global/local color corrections in the multi-channel image), and a sharpening unit 118 (e.g., configured to perform global/local sharpening corrections in the multi-channel image). It is noted that image analyzer 110 is not limited to the aforementioned processing units, and that the image analyzer 110 can incorporate any number of processing units, configured to perform any processing of/modifications to the multi-channel images 108, without departing from the scope of this disclosure.

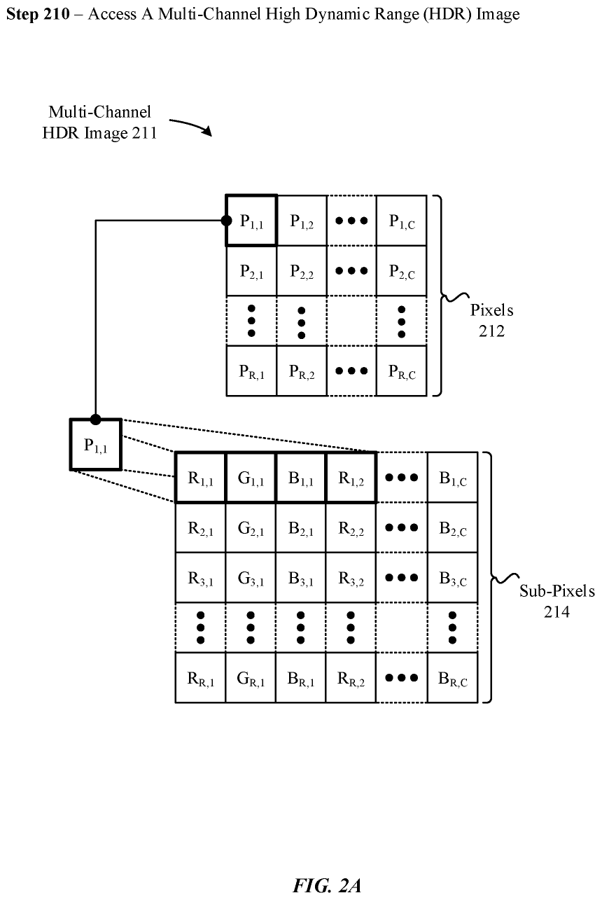

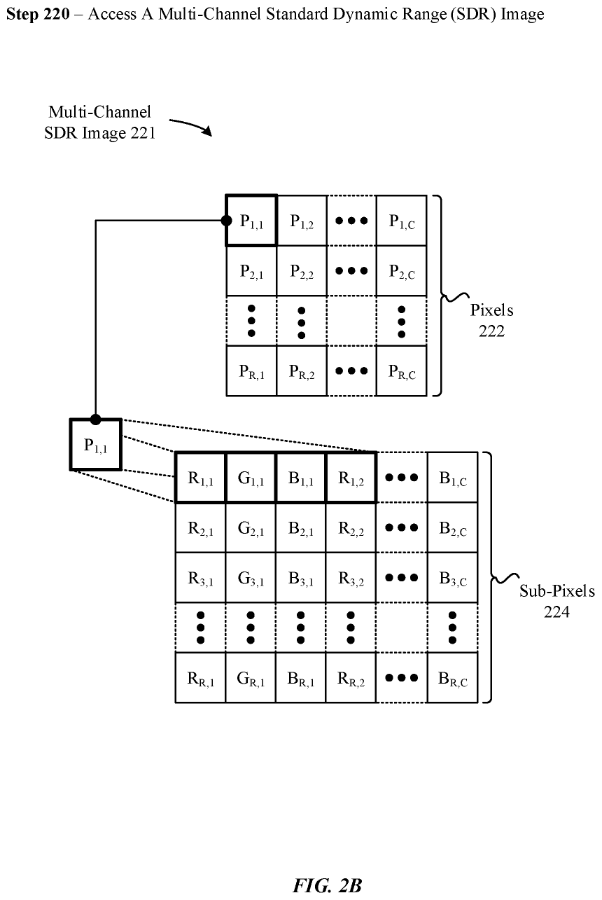

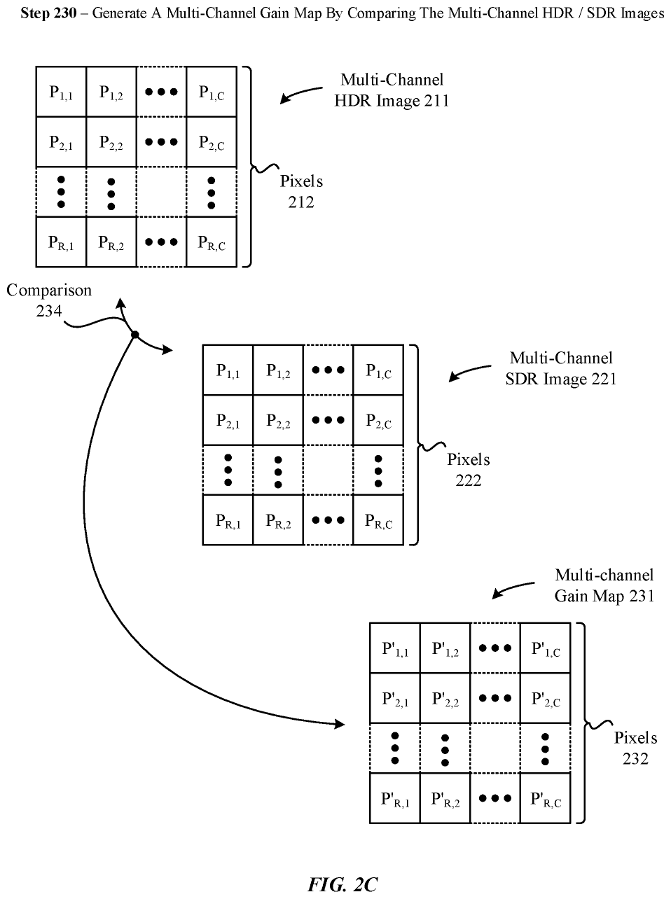

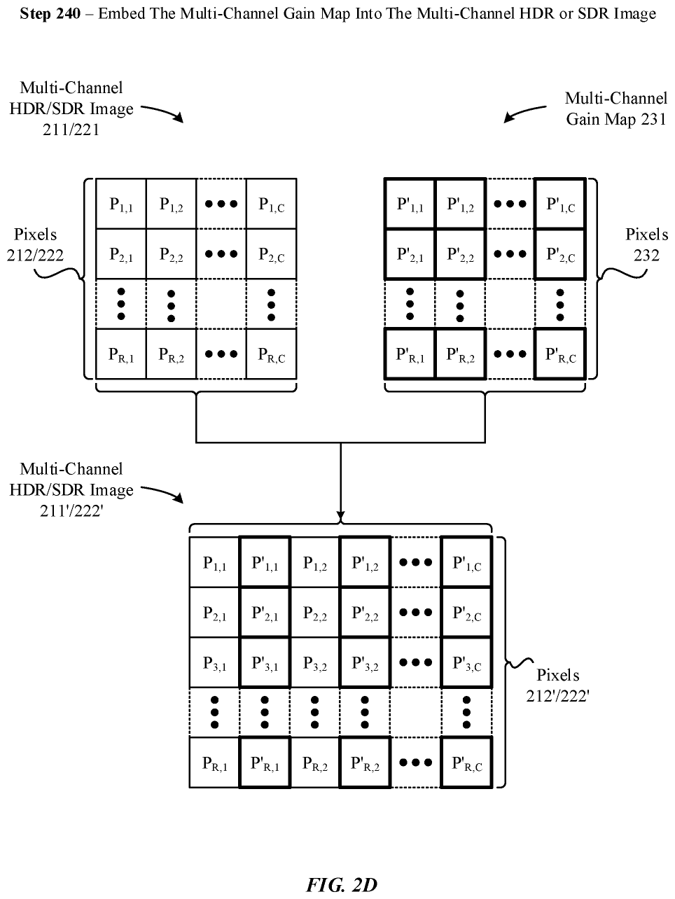

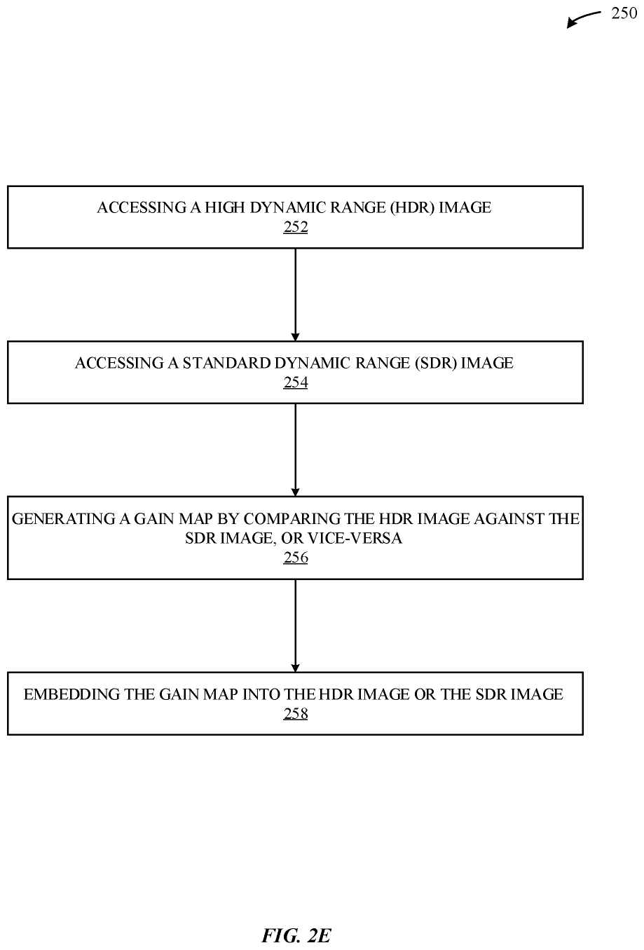

As shown in FIG. 1, the multi-channel images 108 can be provided to the gain map generator 120 after being processed by the image analyzer 110. However, it is noted that the multi-channel images 108 can bypass the image analyzer 110 and be provided to the gain map generator 120, if so desired, without departing from the scope of this disclosure. It is also noted that the multi-channel images 108 can bypass one or more of the processing units of the image analyzer 110 without departing from the scope of this disclosure. For example, two given multi-channel images may be passed through the tone mapping unit 112 to receive local tone mapping modifications, and then bypass the remaining process units in the image analyzer 110. In this regard, the two multi-channel images—which have undergone local tone mapping operations— can be utilized to generate a gain map 123 that reflects the local tone mapping operations that were performed. In any case—and, as described in greater detail herein—the gain map generator 120 can, upon receiving two multi-channel images 108, generate a gain map 123 based on the two multi-channel images 108. In turn, the gain map generator 120 can store the gain map 123 into one of the two multi-channel images 108 to produce an enhanced multi-channel image 122. It is additionally noted that the gain map generation techniques can be performed at any time relative to the receipt of the multi-channel images on which the gain map will be based. For example, the gain map generator 120 can be configured to defer the generation of a gain map when the digital imaging unit is in active use in order to ensure adequate processing resources are available so that slowdowns will not be imposed on users. A more detailed breakdown of the manners in which the gain map generator 120 can generate gain maps 123 is provided below in conjunction with FIGS. 2A-2E, 3A-3G, and 4A-4E.

Additionally, and although not illustrated in FIG. 1, one or more compressors can be implemented on the computing device 102, for compressing the enhanced multi-channel images 122. For example, the compressors can implement Lempel-Ziv-Welch (LZW)-based compressors, other types of compressors, combinations of compressors, and so on. Moreover, the compressor(s) can be implemented in any manner to establish an environment that is most efficient for compressing the enhanced multi-channel images 122. For example, multiple buffers can be instantiated (where pixels can be pre-processed in parallel), and each buffer can be tied to a respective compressor such that the buffers can be simultaneously compressed in parallel as well. Moreover, the same or a different type of compressor can be tied to each of the buffers based on the formatting of the enhanced multi-channel images 122.

Accordingly, FIG. 1 provides a high-level overview of different hardware/software architectures that can be implemented by computing device 102 in order to carry out the various techniques described herein. A more detailed breakdown of these techniques will now be provided below in conjunction with FIGS. 2A-2E.

FIGS. 2A-2E illustrate a sequence of conceptual diagrams of a technique for generating a gain map based on an SDR image and an HDR image, according to some embodiments. As shown in FIG. 2A, a step 210 can involve the computing device 102 accessing a multi-channel HDR image 211, which is composed of pixels 212 (each denoted as “P”). As shown in FIG. 2A, the pixels 212 can be arranged according to a row/column layout, where the subscript of each pixel 212 “P” (e.g., “1,1”) indicates the location of the pixel 212 in accordance with the rows and columns. In the example illustrated in FIG. 2A, the pixels 212 of the multi-channel image 108 are arranged in an equal number of rows and columns, such that the multi-channel image 108 is a square image. However, it is noted that the techniques described herein can be applied to multi-channel images 108 having different layouts (e.g., disproportionate row/column counts). In any case, and as additionally shown in FIG. 2A, each pixel 212 can be composed of three sub-pixels 214—a red sub-pixel 214 (denoted “R”), a green sub-pixel 214 (denoted “G”), and a blue sub-pixel (denoted “B”) 214. It is noted, however, that each pixel 212 can be composed of any number of sub-pixels without departing from the scope of this disclosure.

FIG. 2B illustrates a step 220 that involves the computing device 102 accessing a multi-channel SDR image 221. As shown in FIG. 2B, the multi-channel SDR image 221 is composed of pixels 222 (and sub-pixels 224) similar to the pixels 212 (and sub-pixels 214) of the multi-channel HDR image 211 illustrated in FIG. 2A. According to some embodiments, the multi-channel SDR image 221 is a single-exposure capture of the same scene captured by the multi-channel HDR image 211, such that the multi-channel SDR image 221 and the multi-channel HDR image 211 are substantially related to one another. For example, if the multi-channel HDR image 211 was generated using the EV−, EV0, and EV+ approach described herein, then the multi-channel SDR image 221 can be based on the EV0 exposure (e.g., prior to the EV0 exposure being merged with the EV- and the EV+ exposures to generate the multi-channel HDR image 211). This approach can ensure that both the multi-channel HDR image 211 and the multi-channel SDR image 221 correspond to the same scene at the same moment of time. In this manner, the pixels of the multi-channel HDR image 211 and the multi-channel SDR image 221 may differ only in luminosities gathered from the same points of the same scene (as opposed to differing in scene content due to movements stemming from the passage of time that would occur through sequentially captured exposures).

FIG. 2C illustrates a step 230 that involves the computing device 102 generating a multi-channel gain map 231 (composed of pixels 232) by comparing the multi-channel HDR image 211 and the multi-channel SDR image 221 (illustrated in FIG. 2C as the comparison 234). Here, a first approach can be utilized if it is desirable to enable the multi-channel SDR image 221 to be reproduced using the multi-channel HDR image 211. In particular, the first approach involves dividing the value of each pixel of the multi-channel SDR image 221 by the value of the corresponding pixel of the multi-channel HDR image 211 to produce a quotient. In turn, the respective quotients can be assigned to the values of the corresponding pixels 232 in the multi-channel gain map 231. For example, if the pixel denoted “P_{1,1}” of the multi-channel HDR image 211 has a value of “5”, and the pixel denoted “P_{1,1}” of the multi-channel SDR image 221 has a value of “1”, then the quotient would be “0.2”, and would be assigned to the value of the pixel denoted “P 1, 1” of multi-channel gain map 231. In this manner—and, as described in greater detail herein—the pixel denoted “P_{1,1}” of the multi-channel SDR image 221 could be reproduced by multiplying the pixel denoted “P_{1,1}” of the multi-channel HDR image 211 (having a value of “5”) by the pixel denoted “P_{1,1}” of multi-channel gain map 231 (having a value of “0.2”). In particular, the multiplication would generate a product of “1”, which matches the value “1” of the pixel denoted “P_{1,1}” of the multi-channel SDR image 221. Accordingly, storing the multi-channel gain map 231 with the multi-channel HDR image 211 can enable the multi-channel SDR image 221 to be reproduced independent from the multi-channel SDR image 221 itself. A more detailed description of the various manners in which the multi-channel gain map 231 can be stored with counterpart multi-channel images is described below in conjunction with FIG. 2D.

Alternatively, a second (different) approach can be utilized if it is instead desirable to enable the multi-channel HDR image 211 to be reproduced using the multi-channel SDR image 221. In particular, the second approach involves dividing the value of each pixel of the multi-channel HDR image 211 by the value of the corresponding pixel of the multi-channel SDR image 221 to produce a quotient. In turn, the respective quotients can be assigned to the values of the corresponding pixels 232 in the multi-channel gain map 231. For example, if the pixel denoted “P_{1,1}” of the multi-channel SDR image 221 has a value of “3”, and the pixel denoted “P_{1,1}” of the multi-channel HDR image 211 has a value of “6”, then the quotient would be “2”, and would be assigned to the value of the pixel denoted “P_{1,1}” of multi-channel gain map 231. In this manner and, as described in greater detail herein—the pixel denoted “P_{1,1}” of the multi-channel HDR image 211 could be reproduced by multiplying the pixel denoted “P_{1,1}” of the multi-channel SDR image 221 (having a value of “3”) by the pixel denoted “P_{1,1}” of multi-channel gain map 231 (having a value of “2”). In particular, the multiplication would generate a product of “6”, which matches the value “6” of the pixel denoted “P_{1,1}” of the multi-channel SDR image 221. Accordingly, storing the multi-channel gain map 231 with the multi-channel SDR image 221 can enable the multi-channel HDR image 211 to be reproduced independent from the multi-channel HDR image 211 itself. Again, a more detailed description of the various manners in which the multi-channel gain map 231 can be stored with counterpart multi-channel images is described below in conjunction with FIG. 2D.

As a brief aside, it is noted that although the comparisons illustrated in FIG. 2C (and described herein) constitute pixel-level comparisons, the embodiments are not so limited. On the contrary, the pixels of the images can be compared to one another, at any level of granularity, without departing from the scope of this disclosure. For example, the sub-pixels of the multi-channel HDR image 211 and the multi-channel SDR image 221 can be compared to one another (instead of or in addition to pixel-level comparisons) such that multiple gain maps are generated under different comparison approaches (e.g., a respective gain map for each channel of color).

Additionally, it is noted that various optimizations can be employed when generating the gain maps, without departing from the scope of this disclosure. For example, when two values are identical to one another, the comparison operation can be skipped, and a single bit value (e.g., “0”) can be assigned to the corresponding value in the gain map to minimize the size of (i.e., storage requirements for) the gain map. Additionally, the resolution of a gain map can smaller than the resolution of the images that are compared to generate the gain map. For example, an approximation of every four pixels in a first image can be compared against an approximation of every four corresponding pixels in a second image in order to generate a gain map that is one quarter of the resolution of the first and second images. This approach would substantially reduce the size of the gain map but would lower the overall accuracy by which the first image can be reproduced from the second image and the gain map (or vice versa). Additionally, first and second images can be resampled in any conceivable fashion prior to generating a gain map. For example, the first and second images could undergo local tone mapping operations prior to generating a gain map. In some embodiments, first and second images used to generate a gain map can undergo local tone mapping operations prior to generating a gain map. In some embodiments, a global tone map is generated and used with a gain map that provides locally adaptive tone mapping. In some embodiments, a gain map is stored at multiple resolutions (or as a multi-scale image) and different gain map values can be obtained from the gain map to use with different size images to be displayed using the gain map

FIG. 2D illustrates a step 240 that involves the computing device 102 embedding the multi-channel gain map 231 into the multi-channel HDR image 211 or the multi-channel SDR image 221, according to some embodiments. In particular, if the first approach discussed above in conjunction with FIG. 2C is utilized—which enables the multi-channel SDR image 221 to be reproduced using the multi-channel HDR image 211 and the multi-channel gain map 231—then the computing device 102 embeds the multi-channel gain map 231 into the multi-channel HDR image 211 (thereby yielding an enhanced multi-channel image 122). As shown in FIG. 2D, one approach for embedding the multi-channel gain map 231 into the multi-channel HDR image 211 involves interleaving each pixel 232 (of the multi-channel gain map 231) against its corresponding pixel 212 (of the multi-channel HDR image 211). An alternative approach can involve embedding each pixel 232 (of the multi-channel gain map 231) into its corresponding pixel 212 (of the multi-channel gain map 231) as an additional channel of the pixel 212. Yet another approach can involve embedding the multi-channel gain map 231 as metadata that is stored with the multi-channel HDR image 211. It is noted that the foregoing approaches are exemplary and not meant to be limiting, and that the multi-channel gain map 231 (as well as other supplemental gain maps, if generated) can be stored with the multi-channel HDR image 211, using any conceivable approach, without departing from the scope of this disclosure.

FIG. 2E illustrates a method 250 for generating a gain map based on an SDR image and an HDR image, according to some embodiments. As shown in FIG. 2E, the method 250 begins at step 252, where the computing device 102 accesses an HDR image (e.g., as described above in conjunction with FIG. 2A). At step 254, computing device 102 accesses an SDR image (e.g., as described above in conjunction with FIG. 2B). At step 256, computing device 102 generates a gain map by comparing the HDR image against the SDR image, or vice-versa (e.g., as described above in conjunction with FIG. 2C). At step 258, computing device 102 embeds the gain map into the HDR image or the SDR image (e.g., as described above in conjunction with FIG. 2D, thereby yielding an enhanced multi-channel image 122).

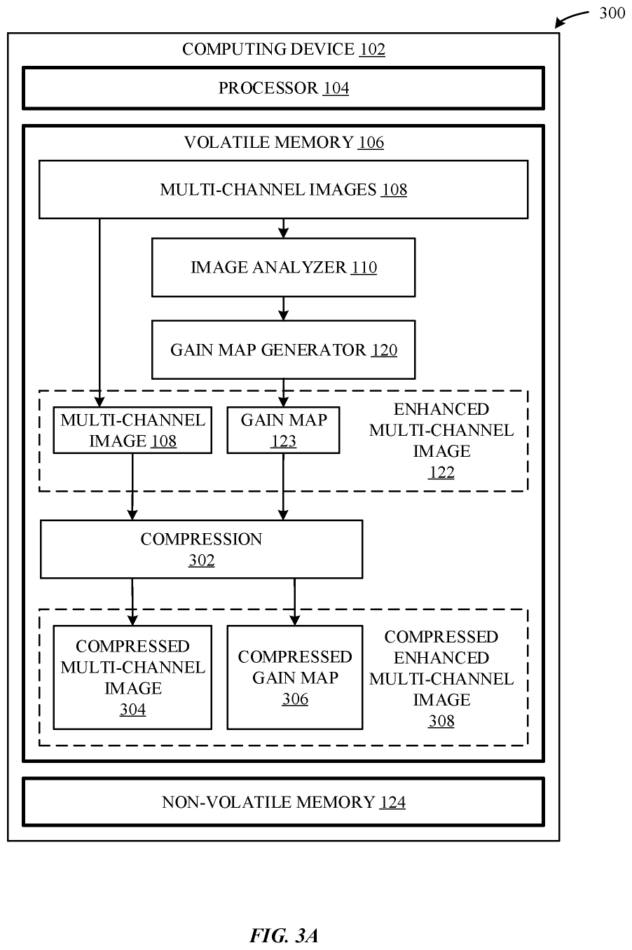

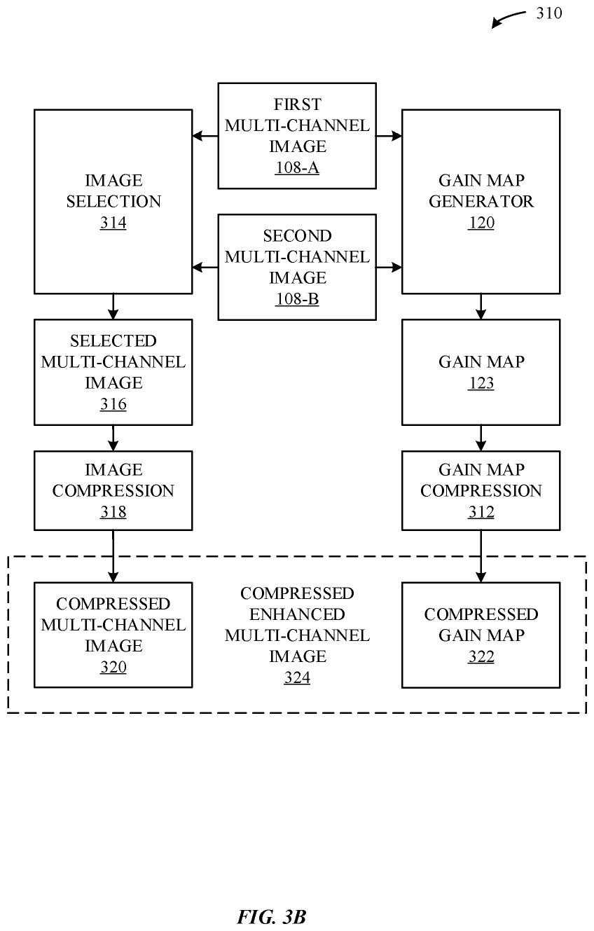

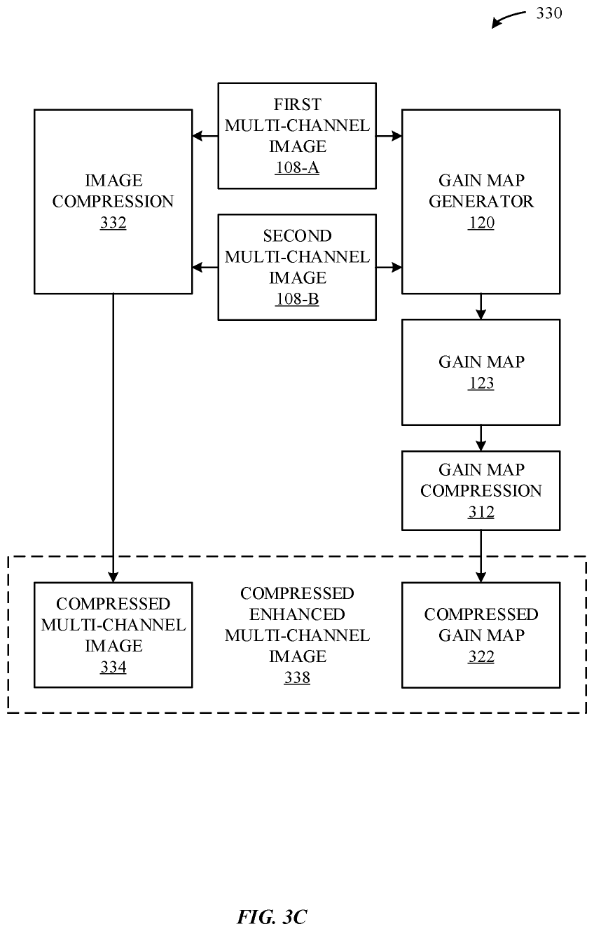

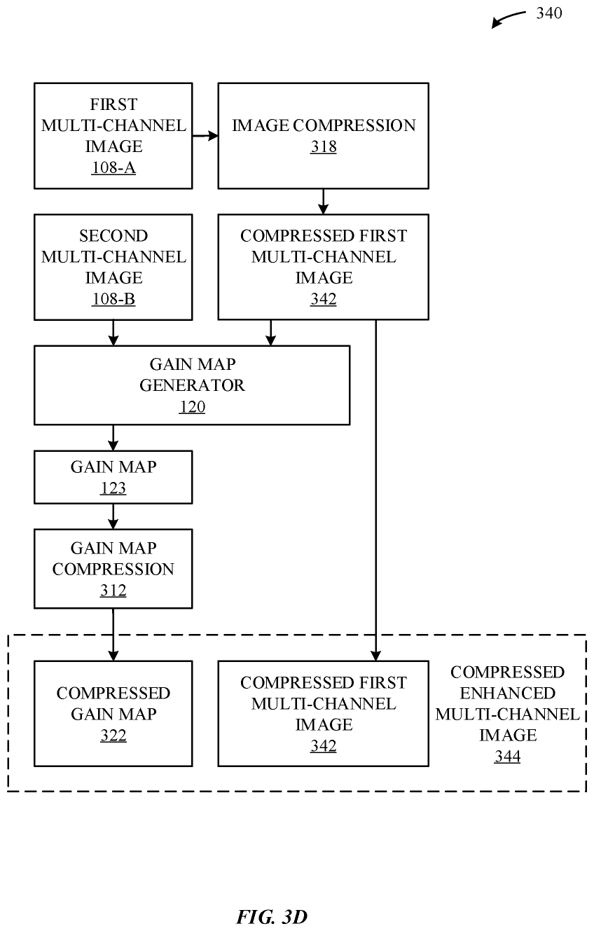

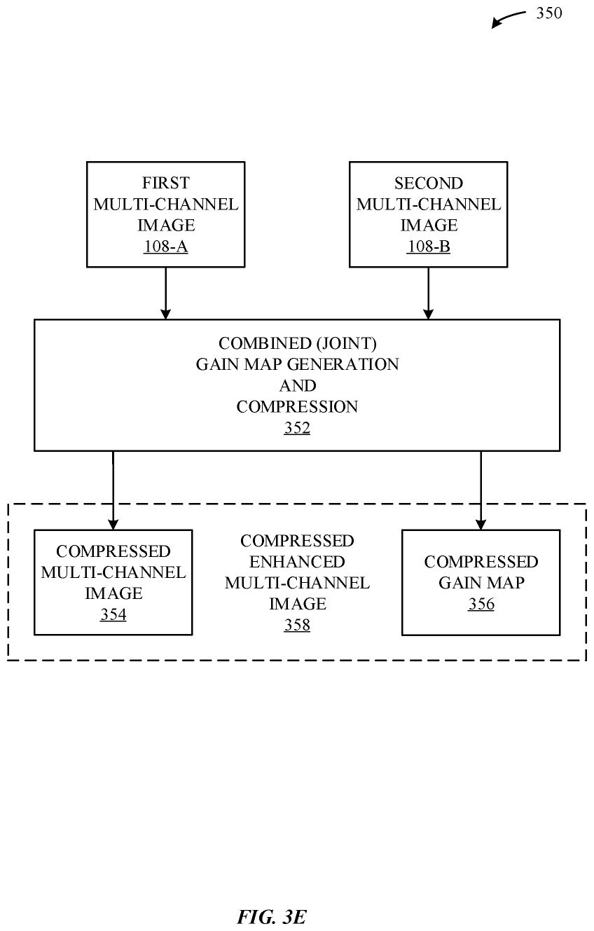

FIG. 3A illustrates a diagram 300 of the computing device 102 of FIG. 1 with additional computational modules to generate a compressed enhanced multi-channel image 308 from the enhanced multi-channel image 122, the generation of which was described previously herein. The enhanced multi-channel image 122 includes a gain map 123 generated by comparing at least two multi-channel images 108 paired with one of the multi-channel images 108. In some embodiments, a compression module 302 processes the multi-channel image 108 (which can be in an uncompressed form) individually, or jointly with the gain map 123, to form a compressed multi-channel image 304. The compression module 302 also processes the gain map 123 (which can be in an uncompressed form) individually, or jointly with the multi-channel image 108, to form a compressed gain map 306. The compressed multi-channel image 304 can be combined with the compressed gain map 306 to form the compressed enhanced multi-channel image 308, which can be stored locally, e.g., in non-volatile memory 124 (or another local storage medium) of the computing device 102, and/or can be stored remotely, e.g., in a cloud-network based service, such as iCloud® managed by Apple®. In some embodiments, the remotely stored compressed enhanced multi-channel image 308 can be obtained by a second computing device 102 and used to generate an uncompressed image with a dynamic range of luminance values suitable for display by the second computing device 102.

FIG. 3B illustrates a diagram 310 for generating a compressed enhanced multi-channel image 324 by a computing device 102. A gain map generator 120 can compare luminance values of pixels in a first multi-channel image 108-A to luminance values of pixels in a second multi-channel image 108-B to generate a gain map 123. The gain map 123 can be defined based on a bit depth for each gain map value, e.g., at least 10 bits, and a gain map resolution, which can possibly include down sampling to reduce storage requirements for the gain map 123. In some embodiments, the gain map 123 is reduced from a full resolution, in which each gain map value in the gain map 123 corresponds to a single pixel in each of the first and second multi-channel images 108-A, 108-B, to a lower resolution, in which each gain value in the gain map 123 corresponds to multiple pixels in each of the first and second multi-channel images 108-A, 108-B. Reducing the resolution of the gain map 123 can impact image quality when using the gain map 123 with an uncompressed version of the compressed multi-channel image 320 having a first dynamic range to generate a second image having a second dynamic range for display. Decreased resolution for the gain map 123 typically results in reduced contrast of images generated subsequently using the gain map 123. In some cases, a ½ or ¼ resolution (the latter representing ½ resolution in each dimension of an image) for a gain map 123 has a limited impact on the image quality for subsequently generated images using the gain map 123. A gain map 123 provides a representation of luminance differences between images with different dynamic ranges, e.g., between an SDR image and an HDR image. In some cases, the first multi-channel image 108-A is an ideal (or reference) SDR image for a scene and the second multi-channel image 108-B is an ideal (or reference) HDR image for the scene. The ideal SDR and HDR images can be generated manually by a user of the computing device 102, e.g., using an image processing application, or can be generated automatically by an image capture application of the computing device 102. The gain map 123 is intended to allow for storing only one image of the scene, e.g., the SDR image (or a version derived therefrom) or the HDR image (or a version derived therefrom) and subsequently generated a corresponding complementary image of the scene. For example, the SDR image can be stored with a gain map 123 and later an HDR image can be generated by applying the gain map 123 to the SDR image. The gain map 123, depending on its resolution, allows for applying local tone mapping within a smaller area of an image than a global tone map that would apply to the entire image. Global tone mapping affects an entire image, where each pixel of the image is mapped using the same function for each pixel without considering local context of pixels nearby. Local tone mapping affects a local region of the image and considers pixels adjacent to individual pixels to determine mapping functions and can result in improved contrast between neighboring pixels compared to global tone mapping. In the embodiments described herein, a primary goal is to generate one base image derived from multiple (typically two) images that are each optimized for different dynamic ranges of luminance along with a gain map 123 that captures differences between the multiple images. In some embodiments, the base image can be used to generate a first display image having a first dynamic range, e.g., an SDR display image, and the base image together with the gain map can be used to generate a second display image having a second dynamic range, e.g., an HDR display image. A full resolution gain map 123 that includes gain values to use for each pixel in the associated base image can provide a high quality level but require a substantial amount of storage. In some embodiments, the base image is an SDR image, and multiple gain maps 123 are generated, where each gain map 123 is associated with a different HDR display capability. Storing the multiple gain maps 123 with the SDR image at full resolution can require more storage than desired by (or available to) a user of the computing device 102. Reducing the resolution of the gain maps 123 provides one form of storage reduction; however, too aggressive resolution reduction of the gain map 123 can result in unnatural results when re-generating HDR images from the SDR (base) image and the gain maps 123 later for display. Compression of the base image and the gain map 123 (with possible modest resolution reduction of the gain map 123, such as at ½ resolution, corresponding to a gain map value for every pair of pixels or ¼ resolution, corresponding to a gain map value for every quad of pixels) can provide for compact storage and high quality results.

In a first implementation of image and gain map compression, as illustrated in FIG. 3B, a gain map 123 generated by a gain map generator 120 from a first multi-channel image 108-A and a second multi-channel image 108-B is processed by a gain map compression module 312 to generate a compressed gain map 322. Separately either the first multi-channel image 108-A or the second multi-channel image 108-B is selected by an image selection module 314, and the selected multi-channel image 316 is processed by an image compression module 318 to produce a compressed multi-channel image 320. The compressed multi-channel image 320 can be combined with the compressed gain map 322 to form the compressed enhanced multi-channel image 324, which can be stored locally at the computing device 102 or remotely at an external storage device, such as at a cloud-network based service accessible to the computing device 102. The compressed multi-channel image 320 can be later decompressed (or un-compressed) to replicate the selected multi-channel image 316 (which can be the first multi-channel image 108-A or the second multi-channel image 108-B). The compressed gain map 322 can be also decompressed (or un-compressed) to reproduce the gain map 123, which can be combined with the un-compressed version of the compressed multi-channel image 320 to produce a version of the first or second (i.e., the unselected) multi-channel image 108-A, 108-B. In some embodiments, the image compression module 318 uses an image compression algorithm that is optimized for processing images, while the gain map compression module 312 uses a gain map compression algorithm that is optimized for processing gain maps 123, which can have substantially different characteristics from images.

FIG. 3C illustrates a diagram 330 of another technique to generate a compressed enhanced multi-channel image 338. A gain map generator 120 processes a first multi-channel image 108-A and a second multi-channel image 108-B to generate a gain map 123, which is processed by a gain map compression module 312 to form a compressed gain map 306. Separately the first multi-channel image 108-A and the second multi-channel image 108-B are processed jointly by an image compression module 332 to form a compressed multi-channel image 334. The compressed multi-channel-334 and the compressed gain map 306 are combined to form the compressed multi-channel image 338. In the technique of FIG. 3B, either the first multi-channel image 108-A or the second multi-channel image 108-B is selected and compressed to form the compressed multi-channel image 320, while in the technique of FIG. 3C, both the first and second multi-channel images 108-A, 108-B are processed together to generated the compressed multi-channel image 334. In some embodiments, the compressed multi-channel image 334 can be decompressed (or un-compressed) to form a version of either the first multi-channel image 108-A or the second multi-channel image 108-B. In some embodiments, the compressed multi-channel image 334 can be decompressed (or un-compressed) and combined with a decompressed version of the gain map 123 obtained from the compressed gain map 306 to form a corresponding complementary version of either the second multi-channel image 108-B or the first multi-channel image 108-A. The first and second multi-channel images 108-A, 108-B can have different dynamic ranges of luminance values, and the corresponding recreated versions of the first and second multi-channel images 108-A, 108-B can also have different dynamic ranges of luminance values.

FIG. 3D illustrates a diagram 340 of a further technique to generate a compressed enhanced multi-channel image 344. A first multi-channel image 108-A (which can be an SDR image or an HDR image) can be processed by an image compression module 318 to generate a compressed first multi-channel image 342. A second multi-channel image 108-B (which can be a complementary HDR image or a complementary SDR image) can be processed with the compressed first multi-channel image 342 by a gain map generator 120 to generate a gain map 123. The gain map 123 can be subsequently processed by a gain map compression module 312 to form a compressed gain map 322 that can be combined with the compressed first multi-channel image 342 to form the compressed enhanced multi-channel image 344, which can be stored locally at the computing device 102 or remotely at an accessible storage facility separate from the computing device 102, such as at a cloud-network based server. The compressed enhanced multi-channel image 344 can be obtained from local or remote storage by the computing device 102 (or in some cases by another computing device 102) and used to regenerate versions of the first and second multi-channel images 108-A, 108-B. The compressed first multi-channel image 342 can be extracted from the compressed enhanced multi-channel image 344 and decompressed (or un-compressed) to replicate a version of the first multi-channel image 108-A. The compressed gain map 322 can be extracted from the compressed enhanced multi-channel image 344 and decompressed (or un-compressed) to obtain a version of the gain map 123, which can be combined with the version of the first multi-channel image 108-A to generate a version of the second multi-channel image 108-B suitable for a display.

In some cases, the implementations illustrated in FIGS. 3B to 3D, where the selected multi-channel image 316 and the gain map 123 are compressed independently is less than ideal, as the selected multi-channel image 316 and the gain map 123 can be strongly correlated to each other. Independent compression and subsequent decompression (or un-compression) of the compressed multi-channel image 320 and the compressed gain map 322 followed by application of the decompressed gain map to the decompressed multi-channel image can result in compression artifacts in the resulting image. For example, a compression artifact affecting a gain map pixel (or set of pixels) and a separate compression artifact impacting an image pixel (or set of pixels) can result in substantial errors when decompressing the gain map and applying the gain map 123 to the decompressed image. Improved implementations of compression can include joint (or closed loop) compression that uses a combination of the image with the gain map 123 to generate the compressed versions included in the compressed enhanced multi-channel image.

FIG. 3E illustrates a diagram 350 of another example of generating a compressed enhanced multi-channel image 358. A combined (joint) gain map generation and compression module 352 processes a first multi-channel image 108-A and a second multi-channel image 108-B jointly to form a compressed enhanced multi-channel image 358 that includes a compressed multi-channel image 354 and a compressed gain map 356. The first and second multi-channel images 108-A, 108-B can each have different dynamic ranges of luminance values, e.g., the first multi-channel image 108-A can be an SDR multi-channel image, while the second multi-channel image 108-B can be an HDR multi-channel image. In some embodiments, a version of one of the first and second multi-channel images 108-A, 108-B can be generated using the compressed multi-channel image 354, while a version of the other of the first and second multi-channel images 108-A, 108-B can be generated using the compressed multi-channel image 354 in combination with the compressed gain map 356.

In some embodiments, additional metadata is generated and stored with the compressed enhanced multi-channel images 308, 324, 338, 344, 358. Exemplary metadata include content information such as whether the images include human faces, a maximum amount of headroom available for processing image content, an offset value for the gain map 123, and/or an error map associated with compression artifacts of the compressed gain map.

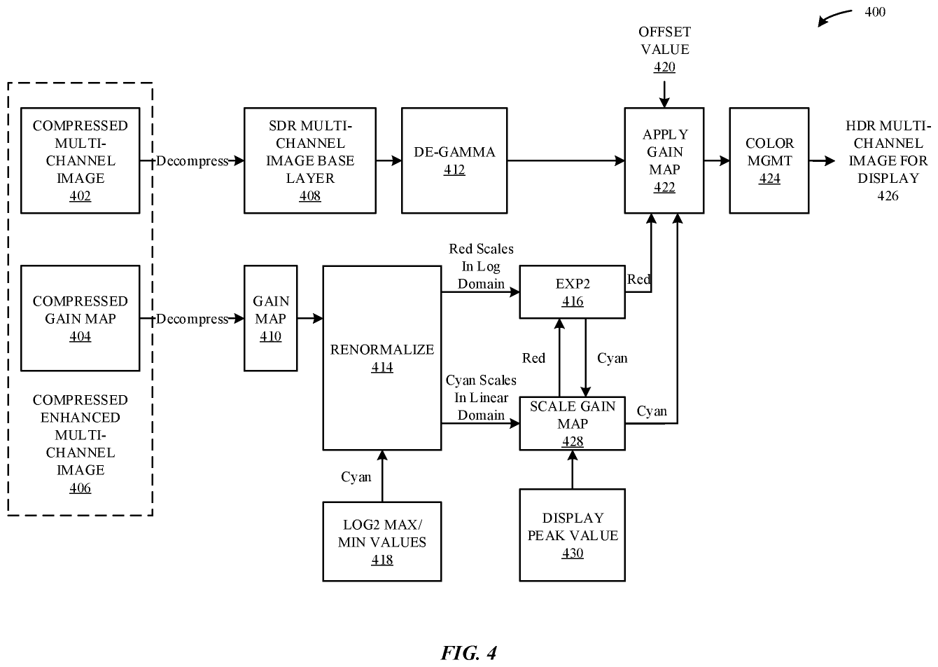

FIG. 4 illustrates a diagram 400 of an example of generating an HDR multi-channel image 426 targeted for a display by a computing device 102 from a compressed enhanced multi-channel image 406. The compressed enhanced multi-channel image 406 can be previously generated by the computing device 102 that decompresses and generates the HDR multi-channel image 426 targeted for the display or by a separate computing device 102. For example, the compressed multi-channel image 406 can be generated on a first computing device 102, stored at a cloud-network based server, retrieved by a second computing device 102, and processed by the second computing device 102 to present on a display associated with the second computing device 102. The HDR multi-channel image 426 generated for display by the second computing device 102 can be processed in accordance with known properties of the display, which may not be known when the compressed enhanced multi-channel image 406 is generated by the first computing device 102.

The computing device 102 can extract the compressed multi-channel image 402 from the compressed enhanced multi-channel image 406, decompress the extracted compressed enhanced multi-channel image 406 to generate a multi-channel image base layer 408, which in some embodiments can in an SDR format. The computing device 102 can also extract the compressed gain map 404 from the compressed enhanced multi-channel image 406, decompress the extracted compressed gain map 404 to generate an uncompressed version of the gain map 410. The gain map 410 can be processed by a renormalization module 414, which accounts for minimum and maximum logarithmic (log 2) values 418 when processing for different color channels. In some cases, gain map values for a red channel are scaled and processed in a logarithmic domain, including via an exponential functional module 416, while gain map values for a cyan channel are scaled and processed in a linear domain. The gain map 410 values can be appropriately scaled in a gain map scaling module 428 using knowledge of a peak value 430 for a display on which the final HDR multi-channel image 426 is intended for display. The scaled gain map values for the color channels can be applied to the multi-channel image base layer 408 (after passing through an applicable de-gamma function module 412) at a gain mapping module 422, which also uses an offset value 420 previously stored as metadata with the compressed gain map 404. The output of the gain mapping module 422 is further processed by a color management module 424 to produce the HDR multi-channel image that is optimized for a particular display. In some embodiments, metadata, such as the offset value 420 and the minimum and maximum log2 values 418 are stored with the gain map 410 (and compressed with the gain map 410) or stored alongside the compressed gain map 404. In some embodiments, the gain map 410 uses normalized values having a range of valid values from zero to one, and the re-normalized version of the gain map 410 includes a full range of gain map values as originally calculated when determining the original version of the gain map 410 (when comparing the original SDR and HDR images). In some embodiments, the re-normalized gain map values are log2 scaled values, and linear versions of the re-normalized gain map values are exponential values, e.g., a log2 scaled value x corresponds to a linear scaled value 2^{x}. In some embodiments, scaling of a portion of the gain map 410 by the gain map scaling module 428 occurs in the log domain (such as for certain color channels). In some embodiments, scaling of a portion of the gain map 410 by the gain map scaling module 428 occurs in the linear domain (such as for certain other color channels). In some embodiments, an amount of scaling to apply to generate scaled gain map values to apply to a base layer image (after the de-gamma module 412) is based on capabilities of a target display, display environment conditions (e.g., brighter or darker ambient light), and/or other metadata values. In some embodiments, the gain map 410 is generated at a source computing device 102 by computing a ratio of pixel luminance values and adding an offset value 420 to divisor pixel luminance values that are zero to ensure no division by zero in the ratio computation occurs. The offset value 420 can then be removed when applying the regenerated gain map (at the gain mapping module 422). In some embodiments, the offset value 420 can be based on the original SDR image, the original HDR image, and/or selected based on compression and/or gain mapping considerations. In some embodiments, the offset value 420 is selected to optimized gain map storage.

In some embodiments, a computing device 102 determines a gain map 123, compresses the gain map 123 to form a compressed gain map 306, 322, 356, decompresses the compressed gain map 306, 322, 356 to form an uncompressed version of the gain map 123, and compares values in the (original) gain map 123 to values in the uncompressed version of the gain map 123 to determine an error map that captures errors from compression of the gain map 123. The computing device 102 can store the error map with the compressed enhanced multi-channel image 308, 324, 338, 344, 358 (with the compressed gain map 306, 322, 356 or separately with accompanying metadata). In some embodiments, the computing device 102 determines multiple gain maps 123, each gain map 123 intended for a different use, such as for different target displays that have different characteristics, e.g., size, resolution, color gamut range, maximum brightness, or to later present images derived from a base image and the gain maps, each image having different stylistic characteristics, i.e., different versions of an image. For example, the computing device 102 can generate multiple gain maps 123 for different peak display values of 500 nits, 1000 nits, 2000 nits, and 4000 nits, and the multiple gain maps 123 can be used to generate different images optimized for different displays having the different peak display values. In some embodiments, a computing device 102 generates a gain map 123 for a multi-channel image 108 and subsequently transcodes the multi-channel image 108 into another image format different from the image format used for the original multi-channel image 108, such as when changed color spaces used for the images. The computing device 102 can re-compute a gain map for the transcoded multi-channel image 108, either from the original gain map 123 or newly computed based on the transcoded multi-channel image 108.

In some embodiments, a computing device 102 determines a gain map 123 at multiple resolutions, e.g., a multi-scale gain map, which can be compressed and stored with a base image, which may be also at multiple resolutions or can be resampled to multiple resolutions, and the an appropriate gain map can be derived from the multi-scale gain map to apply to the base image (or to a resampled version of the base image) to provide an image at a relevant resolution for display. Thus, a multi-scale gain map can be used to apply locally adaptive tone mapping for images sized for different output displays. In some embodiments, a global tone map is applied to a baseline image before (or after) applying a gain map to obtain an image for display, where the gain map provides adaptive local tone mapping separate from global tone mapping.

FIG. 5A illustrates a flowchart 500 of an exemplary method for image management by a computing device 102. At 502, the computing device generates a compressed version of an image and a compressed version of a gain map from a standard dynamic range (SDR) image of a scene and a high dynamic range (HDR) image of the scene. At 504, the computing device 102 combines the compressed version of the image with the compressed version of the gain map to form compressed enhanced image. At 506, the computing device 102 stores the compressed enhanced image in a non-volatile storage medium.

FIG. 5B illustrates a flowchart 520 of another exemplary method for image management by a second computing device 102. At 522, the second computing device 102 obtains the compressed enhanced image. At 524, the second computing device 102 extracts the compressed version of the image and the compressed version of the gain map from the compressed enhanced image. At 526, the second computing device generates an uncompressed version of the image from the compressed version of the image. At 528, the second computing device generates an uncompressed version of the gain map from the compressed version of the gain map. At 530, the second computing device applies the uncompressed version of the gain map to the uncompressed version of the image to generate a second image formatted for display by the second computing device 102, where the second image and the uncompressed version of the image have different dynamic ranges of luminance values.

In some embodiments, the compressed image includes a compressed version of the SDR image. In some embodiments, the second image includes a version of the HDR image. In some embodiments, the compressed image includes a compressed version of the HDR image. In some embodiments, the second image includes a version of the SDR image. In some embodiments, the method performed by the computing device 102 further includes the computing device 102: i) generating a gain map by comparing luminance values of pixels in the HDR image to luminance values of corresponding pixels in the SDR image, ii) generating the compressed version of the image by processing the SDR image or the HDR image with an image compression module, and iii) generating the compressed version of the gain map by processing the gain map with a gain compression module. In some embodiments, the method performed by the computing device 102 further includes the computing device 102: i) generating a gain map by comparing luminance values of pixels in the HDR image to luminance values of corresponding pixels in the SDR image, ii) generating the compressed version of the image by jointly processing the SDR image and the HDR image with an image compression module, and iii) generating the compressed version of the gain map by processing the gain map with a gain compression module. In some embodiments, the method performed by the computing device 102 further includes the computing device 102: i) generating the compressed version of the image by processing the SDR image with an image compression module, ii) generating a gain map by comparing luminance values of pixels in the HDR image to luminance values of corresponding pixels in the compressed version of the image, and iii) generating the compressed version of the gain map by processing the gain map with a gain compression module. In some embodiments, the computing device 102 generates the compressed version of the image and the compressed version of the gain map by jointly generating the compressed version of the gain map and the compressed version of the image from the SDR image and the HDR image using a combined gain map generation and compression module. In some embodiments, the compressed version of the gain map is derived from a gain map having a linear resolution in each of two dimensions identical to the linear resolution of the SDR and HDR images. In some embodiments, the compressed version of the gain map is derived from a gain map having a linear resolution in at least one dimension that is less than the corresponding linear resolution of the SDR and HDR images. In some embodiments, the compressed version of the gain map is generated using a first compression scheme optimized for gain maps, and the compressed version of the image is generating using a second compression scheme optimized for images.

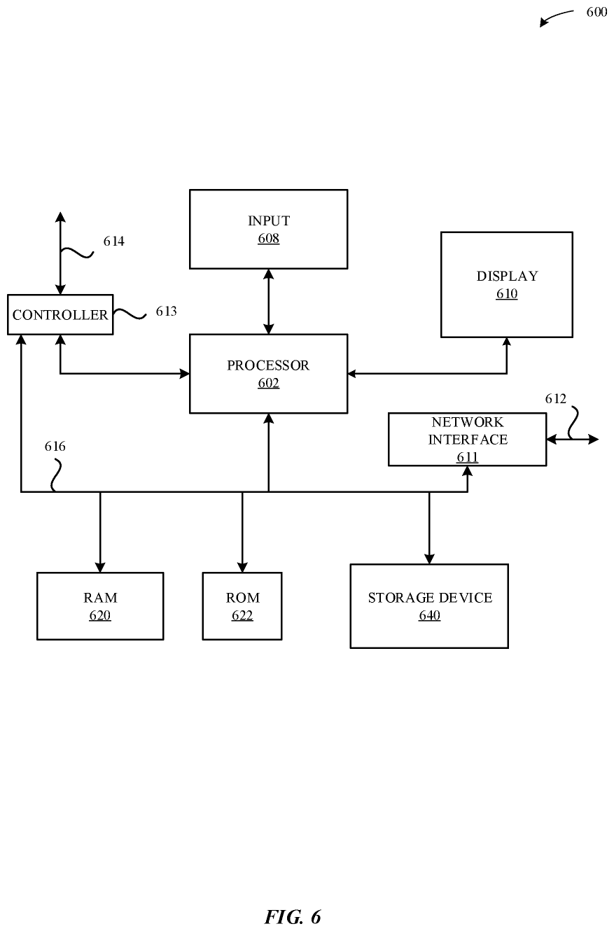

FIG. 6 illustrates a detailed view of a computing device 600 that can be used to implement the various techniques described herein, according to some embodiments. In particular, the detailed view illustrates various components that can be included in the computing device 102 described in conjunction with FIG. 1. As shown in FIG. 6, the computing device 600 can include a processor 602 that represents a microprocessor or controller for controlling the overall operation of the computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, and so on. Still further, the computing device 600 can include a display 610 that can be controlled by the processor 602 (e.g., via a graphics component) to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include a wireless transceiver.

As noted above, the computing device 600 also includes the storage device 640, which can comprise a single disk or a collection of disks (e.g., hard drives). In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities, or processes to be executed in a non-volatile manner. The RAM 620 can provide volatile data storage, and stores instructions related to the operation of applications executing on the computing device 600, e.g., the image analyzer 110/gain map generator 120.

The techniques described herein include a technique for image management. According to some embodiments, the first technique can be implemented by a computing device, and includes the steps of: (1) generating a compressed version of an image and a compressed version of a gain map from a standard dynamic range (SDR) image of a scene and a high dynamic range (HDR) image of the scene; (2) combining the compressed version of the image with the compressed version of the gain map to form a compressed enhanced image; and (3) storing the compressed enhanced image in a non-volatile storage medium.

According to some embodiments, the aforementioned technique can further include the steps of, by a second computing device: (1) obtaining the compressed enhanced image; (2) extracting the compressed version of the image and the compressed version of the gain map from the compressed enhanced image; (3) generating an uncompressed version of the image from the compressed version of the image; (4) generating an uncompressed version of the gain map from the compressed version of the gain map; and (5) applying the uncompressed version of the gain map to the uncompressed version of the image to generate a second image formatted for display by the second computing device, wherein the second image and the uncompressed version of the image have different dynamic ranges of luminance values.

According to some embodiments, the compressed version of the image comprises a compressed version of the SDR image; and the second image comprises a version of the HDR image. According to some embodiments, the compressed version of the image comprises a compressed version of the HDR image; and the second image comprises a version of the SDR image. According to some embodiments, the compressed version of the gain map is generated using a lossy compression module selected for use with gain map compression. According to some embodiments, the compressed version of the image is generated using a lossy compression module selected for use with image compression.

According to some embodiments, generating the compressed version of the image and the compressed version of the gain map comprises: (1) generating a gain map by comparing luminance values of pixels in the HDR image to luminance values of corresponding pixels in the SDR image; (2) generating the compressed version of the image by processing the SDR image or the HDR image with an image compression module; and (3) generating the compressed version of the gain map by processing the gain map with a gain compression module.

According to some embodiments, generating the compressed version of the image and the compressed version of the gain map comprises: (1) generating a gain map by comparing luminance values of pixels in the HDR image to luminance values of corresponding pixels in the SDR image; (2) generating the compressed version of the image by jointly processing the SDR image and the HDR image with an image compression module; and (3) generating the compressed version of the gain map by processing the gain map with a gain compression module.

According to some embodiments, generating the compressed version of the image and the compressed version of the gain map comprises: (1) generating the compressed version of the image by processing the SDR image with an image compression module; (2) generating a gain map by comparing luminance values of pixels in the HDR image to luminance values of corresponding pixels in the compressed version of the image; and (3) generating the compressed version of the gain map by processing the gain map with a gain compression module.

According to some embodiments, generating the compressed version of the image and the compressed version of the gain map comprises: jointly generating the compressed version of the gain map and the compressed version of the image from the SDR image and the HDR image using a combined gain map generation and compression module.

According to some embodiments, the compressed version of the gain map is derived from a gain map having a linear resolution in each of two dimensions identical to a linear resolution of the SDR and HDR images. According to some embodiments, the compressed version of the gain map is derived from a gain map having a linear resolution in at least one dimension that is less than a corresponding linear resolution of the SDR and HDR images. According to some embodiments, the compressed version of the gain map is generated using a first compression scheme optimized for gain maps; and the compressed version of the image is generating using a second compression scheme optimized for images.

According to some embodiments, an offset value based on pixel values of the SDR image and/or pixel values of the HDR image is used by the computing device when generating the gain map. According to some embodiments, the offset value is selected by the computing device to optimize storage of the compressed version of the gain map.

According to some embodiments, the aforementioned technique can further include the steps of, by the computing device: (1) generating an uncompressed version of the gain map from the compressed version of the gain map; (2) determining an error map based on comparing the uncompressed version of the gain map to an original gain map used to generate the compressed version of the gain map; and (3) storing a compressed version of the error map with the compressed enhanced image. According to some embodiments, the compressed version of the error map is compressed using a lossless compression module; and the compressed version of the gain map is compressed using a lossy compression module.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for image management, the method comprising, at a computing device:
generating a compressed version of an image and a compressed version of a gain map from a standard dynamic range (SDR) image of a scene and a high dynamic range (HDR) image of the scene;
combining the compressed version of the image with the compressed version of the gain map to form a compressed enhanced image; and
storing the compressed enhanced image in a non-volatile storage medium.

2. The method of claim 1, further comprising, at a second computing device:
obtaining the compressed enhanced image;
extracting the compressed version of the image and the compressed version of the gain map from the compressed enhanced image;
generating an uncompressed version of the image from the compressed version of the image;
generating an uncompressed version of the gain map from the compressed version of the gain map; and
applying the uncompressed version of the gain map to the uncompressed version of the image to generate a second image formatted for display by the second computing device,
wherein the second image and the uncompressed version of the image have different dynamic ranges of luminance values.

3. The method of claim 2, wherein:
the compressed version of the image comprises a compressed version of the SDR image; and
the second image comprises a version of the HDR image.

4. The method of claim 2, wherein:
the compressed version of the image comprises a compressed version of the HDR image; and
the second image comprises a version of the SDR image.

5. The method of claim 1, wherein the compressed version of the gain map is generated using a lossy compression module selected for use with gain map compression.

6. The method of claim 1, wherein the compressed version of the image is generated using a lossy compression module selected for use with image compression.

7. The method of claim 1, wherein generating the compressed version of the image and the compressed version of the gain map comprises:
generating a gain map by comparing luminance values of pixels in the HDR image to luminance values of corresponding pixels in the SDR image;
generating the compressed version of the image by processing the SDR image or the HDR image with an image compression module; and
generating the compressed version of the gain map by processing the gain map with a gain compression module.

8. The method of claim 1, wherein generating the compressed version of the image and the compressed version of the gain map comprises:
generating a gain map by comparing luminance values of pixels in the HDR image to luminance values of corresponding pixels in the SDR image;
generating the compressed version of the image by jointly processing the SDR image and the HDR image with an image compression module; and
generating the compressed version of the gain map by processing the gain map with a gain compression module.

9. The method of claim 1, wherein generating the compressed version of the image and the compressed version of the gain map comprises:
generating the compressed version of the image by processing the SDR image with an image compression module;
generating a gain map by comparing luminance values of pixels in the HDR image to luminance values of corresponding pixels in the compressed version of the image; and
generating the compressed version of the gain map by processing the gain map with a gain compression module.

10. The method of claim 1, wherein generating the compressed version of the image and the compressed version of the gain map comprises:
jointly generating the compressed version of the gain map and the compressed version of the image from the SDR image and the HDR image using a combined gain map generation and compression module.

11. The method of claim 1, wherein the compressed version of the gain map is derived from a gain map having a linear resolution in each of two dimensions identical to a linear resolution of the SDR and HDR images.

12. The method of claim 1, wherein the compressed version of the gain map is derived from a gain map having a linear resolution in at least one dimension that is less than a corresponding linear resolution of the SDR and HDR images.

13. The method of claim 1, wherein:
the compressed version of the gain map is generated using a first compression scheme optimized for gain maps; and
the compressed version of the image is generating using a second compression scheme optimized for images.

14. The method of claim 1, wherein an offset value based on pixel values of the SDR image and/or pixel values of the HDR image is used by the computing device when generating the gain map.

15. The method of claim 14, wherein the offset value is selected by the computing device to optimize storage of the compressed version of the gain map.

16. The method of claim 1, further comprising the computing device:
generating an uncompressed version of the gain map from the compressed version of the gain map;
determining an error map based on comparing the uncompressed version of the gain map to an original gain map used to generate the compressed version of the gain map; and
storing a compressed version of the error map with the compressed enhanced image.

17. The method of claim 16, wherein:
the compressed version of the error map is compressed using a lossless compression module; and
the compressed version of the gain map is compressed using a lossy compression module.

18. A non-transitory computer readable storage medium configured to store instructions that, when executed by at least one processor included in a computing device, cause the computing device to implement a method for image management, by carrying out steps that include:
generating a compressed version of an image and a compressed version of a gain map from a standard dynamic range (SDR) image of a scene and a high dynamic range (HDR) image of the scene;
combining the compressed version of the image with the compressed version of the gain map to form a compressed enhanced image; and
storing the compressed enhanced image in a non-volatile storage medium.

19. The non-transitory computer readable storage medium of claim 18, wherein the steps further include, by a second computing device:
obtaining the compressed enhanced image;
extracting the compressed version of the image and the compressed version of the gain map from the compressed enhanced image;
generating an uncompressed version of the image from the compressed version of the image;
generating an uncompressed version of the gain map from the compressed version of the gain map; and
applying the uncompressed version of the gain map to the uncompressed version of the image to generate a second image formatted for display by the second computing device,
wherein the second image and the uncompressed version of the image have different dynamic ranges of luminance values.

20. A computing device configured to manage images, the computing device comprising:
at least one processor; and
at least one memory configured to store instructions that, when executed by the at least one processor, cause the computing device to carry out steps that include:
generating a compressed version of an image and a compressed version of a gain map from a standard dynamic range (SDR) image of a scene and a high dynamic range (HDR) image of the scene;
combining the compressed version of the image with the compressed version of the gain map to form a compressed enhanced image; and
storing the compressed enhanced image in a non-volatile storage medium.
